(19) United States
(12) Patent Application Publication
(10) Pub. No.: US 2012/0189522 A1
(43) Pub. Date: Jul. 26, 2012

(54) Method of Desulfurizing Flue Gas, an Arrangement for Desulfurizing Flue Gas, and a Method of Modernizing a Desulfurization Arrangement

(75) Inventors: Zhen Fan, Parsippany, NJ (US); Andrew Seltzer, Livingston, NJ (US); Archibald Robertson, JR., Whitehouse Station, NJ (US); Horst Hack, Hampton, NJ (US)

(73) Assignee: FOSTER WHEELER NORTH AMERICA CORP., Clinton, NJ (US)

(21) Appl. No.: 13/010,132

(22) Filed: Jan. 20, 2011

(51) Int. Cl. B01D 53/48; B23P 6/00

(52) U.S. Cl. 423/243.01; 422/168; 29/402.01

(57) ABSTRACT

A method of desulfurizing flue gas in connection with oxy-combustion. A sulfur containing gas flow is introduced to a flue gas desulfurization arrangement having a spray tower at its top part and a reaction tank at its bottom part, in which the reaction tank contains liquid slurry having a surface level L. Sorbent-containing liquid slurry is sprayed to the sulfur containing gas flow. Sulfur-containing molecules are allowed to be absorbed into liquid slurry droplets. The liquid slurry droplets are allowed to enter the liquid slurry in the reaction tank. Oxygen containing gas is bubbled in the liquid slurry from a gas inlet header and nozzles in the reaction tank, in which the nozzles are arranged at a certain level in the reaction tank. Sulfur-containing particulates settle in the reaction tank. The sulfur-containing particulates are removed as a slurry from the reaction tank, and the bubbled gas that has left the liquid slurry is discharged separately from the flue gas from the flue gas desulfurization arrangement.

### TECHNICAL FIELD

The present invention relates to a method of desulfurizing flue gas, an arrangement for desulfurizing flue gas, and a method of modernizing a desulfurization arrangement. This invention is especially applicable in connection with treating flue gas from industrial and utility boilers.

### BACKGROUND OF THE INVENTION

Combusting fuel in industrial and utility boilers, such as those used in power plants, generates flue gas. The flue gas contains a vast number of more or less harmful emissions such as, for instance, carbon dioxide (CO₂), nitrogen oxides (NOₓ), sulfur dioxide (SO₂), and fly ash. Various systems have been developed for controlling these emissions. One of these systems is called a scrubber. Scrubbers are often used for desulfurization of flue gas, i.e., for removing sulfur from flue gas. Scrubber systems are generally of either the dry-type or the wet-type. Dry scrubbers normally include an open chamber in which the flue gas is introduced through a liquid spray of lime and fly ash slurry. A reaction occurs with the sulfur dioxide in the gas to form a calcium compound in dry particulate form, which can then be collected at the outlet of the chamber, thereby “scrubbing” the flue gas free of sulfur dioxide pollutants. In the so-called “wet scrubbers”, the sulfur dioxide is not collected in dry particulate form, but rather, is collected in the form of a slurry in a tank of aqueous absorbent for removal in liquid slurry form. Prior art FIG. 1 shows the construction and operation of a wet scrubber in more detail.

U.S. Pat. No. 4,762,686 discusses a flue gas scrubber system, which is a wet scrubber type particularly adapted for removing both fly ash particulates by wetting, and sulfur dioxide gas by absorption and oxidation, from the flue gas of a power plant in one step. The lower end of the chamber inside the scrubber module is filled with aqueous absorbent having a controlled pH between about 3.5 and 5, while the upper end is divided by a vertical partition into two sub-chambers. Dirty flue gas from the boiler is received in one sub-chamber, while scrubbed or clean flue gas leaves the other sub-chamber, on the other side of the partition, for exhaust through a stack to the atmosphere. The partition takes the form of a zig-zag or corrugated vertical side wall comprising interconnected spaced apart side walls and end walls. The upper edges of the walls are closed by top walls in order to define a series of hollow “fingers”. Adjacent vertical edges of the fingers are closed by side walls. The lower edges of the finger side walls and end walls are continuous, and are submerged in the liquid absorbent. As raw flue gas enters the scrubber chamber, it is directed into the ends of the forgers of the partition, downward around their submerged lower edges and through the liquid absorbent. Simultaneously, an oxygen-containing gas, such as air, is injected into the lower region of the aqueous absorbent beneath the partition, as the absorbent is agitated. The fly ash in the flue gas provides the primary reagent to react with the sulfur dioxide to form a sulfate that precipitates out of solution, and can then be removed as fly ash slurry. The oxygen-containing gas, i.e., air, leaves the scrubber together with the flue gas. If desired, an additional calcium compound, such as limestone, can be added to the aqueous absorbent for best efficiency.

Thus, the normal practice in prior art wet flue gas desulfurization (FGD) methods is to supply air as an oxidant to the scrubber chamber into the liquid absorbent slurry, to enhance the oxidation of CaSO₃ to CaSO₄. The vitiated or oxygen-depleted air after bubbling through the slurry is mixed with flue gas and discharged to the stack. The air or, in general, oxidant, is nearly saturated with all of the other gases, such as CO₂, H₂O, Hg (re-emission), NOₓ, SO₂, etc., that is, those gases that are originally dissolved in solution/slurry. In oxy-combustion, this vitiated or oxygen-depleted air adds tramped gas into the CO₂ stream, which increases the O₂ requirement, reduces CO₂ capture efficiency, and raises the power demand for CO₂ removal. One solution to reduce tramped gas that has been discussed in the literature is to replace the air by pure oxygen. Due to a poor mass transfer coefficient and excess requirements, there is somewhat of an excess of O₂ left over after bubbling through the slurry and being mixed with the CO₂ stream, which increases a penalty for CO₂ removal. This gas tramping will not occur, however, for the FGD with out-situ oxidation when a separated vessel/pond is used for oxidation, but, extra space is required for the out-situ oxidation. It is a trade-off, therefore, between space requirements from out-situ oxidation and avoiding gas tramping from in-situ oxidation. The present invention presents a way to extend the application of FGD with in-situ oxidation for oxyfuel combustion, i.e., presenting a way to avoid gas tramping.

### SUMMARY OF THE INVENTION

An object of the present invention is to find at least one solution to at least one of the problems discussed above.

Another object of the present invention is to improve the construction of a wet flue gas desulfurization arrangement such that the vitiated air is kept apart from the cleaned flue gas.

The above and other objects are met with the method of the present invention of desulfurizing flue gas in connection with oxy-combustion, the method comprising the steps of:
introducing a sulfur-containing gas flow to a flue gas desulfurization arrangement having a spray tower at its top part and a reaction tank at its bottom part, the reaction tank containing liquid slurry having a surface level L;
spraying sorbent-containing liquid slurry to the sulfur containing gas flow;
allowing sulfur-containing molecules to be absorbed into liquid slurry droplets;
allowing the liquid slurry droplets to enter the liquid slurry in the reaction tank;
bubbling oxygen containing gas in the liquid slurry from a gas inlet header and nozzles in the reaction tank, the nozzles being arranged at a certain level in the reaction tank;
allowing sulfur-containing particulates to settle in the reaction tank;
removing the sulfur-containing particulates as a slurry from the reaction tank; and
discharging the bubbled gas that has left the liquid slurry separate from the flue gas from the flue gas desulfurization arrangement.

The above and other objects are met with the arrangement of the present invention for desulfurizing flue gas in connection with oxy-combustion, the arrangement including:
(a) a wall, the wall housing:
   (i) a spray tower at its top part, the spray tower being provided with a sprayer for spraying liquid slurry to the flue gas, and
   (ii) a reaction tank at its bottom part;
(b) a duct below the sprayer for introducing flue gas into the arrangement;
(c) a flue gas discharge above the sprayer for discharging flue gas from the arrangement;
(d) a bubbler for bubbling oxygen-containing gas in the reaction tank;
(e) a circulator for circulating liquid slurry from the reaction tank to the sprayer in the spray tower;
(f) a solids slurry discharge for removing solids slurry from the reaction tank; and
(g) a separator for keeping the bubbled gas and flue gas apart by removing bubbled gas from the desulfurization arrangement separate from the flue gas discharge.

The above and other objects are also met with the method of the present invention of modernizing a desulfurization arrangement for use in connection with oxy-combustion, the desulfurization arrangement including a wall housing a spray tower at its top part, the spray tower having a sprayer for spraying liquid slurry to the flue gas, and a reaction tank at its bottom part, a flue gas discharge above the sprayer for discharging flue gas from the arrangement, and a duct below the sprayer for introducing flue gas into the desulfurization arrangement, the method comprising the step of providing the desulfurization arrangement with a separator for keeping the bubbled gas and flue gas apart by removing bubbled gas from the desulfurization arrangement separate from the flue gas discharge.

Other features of the present invention are presented in the appended claims.

By means of the novel method of desulfurizing flue gas, an arrangement for desulfurizing flue gas, and a method of modernizing a desulfurization arrangement, of the present invention, at least the following advantages over the prior art have been achieved:
the novel wet flue gas desulfurization arrangement can be applied for Flexi-Burn systems, i.e., for both air-firing and oxy-firing;
it avoids the gas tramping from flue gas desulfurization into flue gas in oxy-combustion;
it allows the use of air and avoids the necessity of using pure O₂ for slurry oxidation;
it does not increase the power demand in flue gas desulfurization in the manner that prior art methods do;
it is suitable for retrofit application with the original flue gas desulfurization online for oxy-firing; and
if necessary, pure O₂ from an air separation unit (ASU) can be used, and the leftover O₂ after bubbling can be ducted and/or mixed with recirculation gas to the boiler for combustion with no dilution to flue gas (CO₂ stream).

### DESCRIPTION OF THE DRAWINGS

In the following, the method of desulfurizing flue gas, an arrangement for desulfurizing flue gas, and a method of modernizing a desulfurization arrangement, of the present invention, will be explained in more detail with reference to the following drawings, of which:

FIG. 1 is a schematic, vertical cross-sectional view of a prior art wet flue gas desulfurization arrangement;

FIG. 2 is a schematic, vertical cross-sectional view of a wet flue gas desulfurization arrangement in accordance with a first preferred embodiment of the present invention;

FIG. 3 is a schematic, vertical cross-sectional view of a wet flue gas desulfurization arrangement in accordance with a second preferred embodiment of the present invention;

FIG. 4 is a schematic, vertical cross-sectional view of a wet flue gas desulfurization arrangement in accordance with a third preferred embodiment of the present invention; and

FIG. 5 is a schematic, vertical cross-sectional view of a wet flue gas desulfurization arrangement in accordance with a fourth preferred embodiment of the present invention.

### DETAILED DESCRIPTION

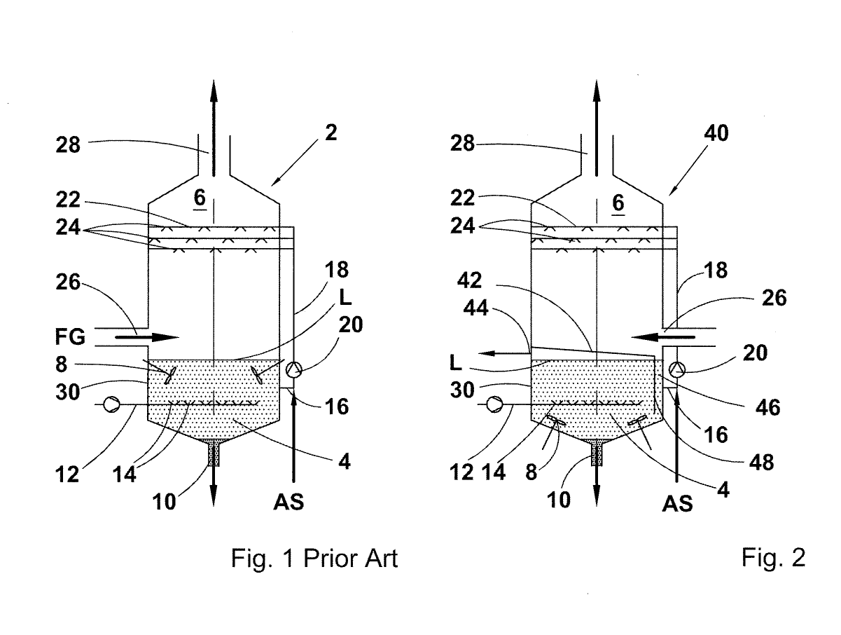

FIG. 1 illustrates a schematic, vertical cross-sectional view of a prior art wet flue gas desulfurization (FGD) arrangement. The wet-FGD arrangement of the prior art comprises a vertical vessel 2, the bottom part of which forms a reaction tank 4, and the top part of which is called a spray tower 6. The reaction tank 4 is, in operating condition, filled with liquid, such as water, up to a certain level L, and provided with one or more agitators 8 for agitating the liquid in the tank 4. The reaction tank 4 is also provided with at least one outlet 10 for discharging settled solids slurry either continuously, at regular intervals, or intermittently, from the bottom of the reaction tank 4. Further, the reaction tank 4 is provided with an inlet header 12 and nozzles 14 for an oxygen containing gas, such as air, that is bubbled from the nozzles 14 into the liquid slurry below the liquid surface L in the reaction tank 4. And, finally, the reaction tank 4 is provided with a liquid slurry outlet 16 connected to a circulation conduit 18 and a pump 20 for circulating the liquid slurry from the reaction tank 4 to the spray tower 6. The spray tower 6 has a set of spray headers 22 with nozzles 24 for spraying the circulated liquid slurry against the flue gas flow entering the spray tower 6 from below. The headers 22 and nozzles 24 are placed across the tower 6 at different heights to be able to spray all of the gas as it moves up through the tower 6. The flue gas (FG) enters the vessel 2 via an inlet opening 26 situated above the liquid level L, but well below the spray headers 22. The cleaned flue gas leaves the vessel 2 via an outlet 28. The wet-FGD arrangement 2 is provided with an outer wall 30, which is preferably (but not necessarily) a cylindrical wall extending from the bottom of the vessel 2 to the top thereof. Thus, the same wall be may be referred to in the following as the side wall 30 of the spray tower 6, as well as that of the reaction tank 4.

The wet-FGD arrangement discussed above functions as follows. The flue gas enters the FGD vessel 2 from a boiler or other combustion equipment after the solids have been at least partially separated from the flue gas. The flue gas enters the vessel 2 via inlet opening 26 above the liquid level L and flows upwardly towards and into the spray tower 6. Liquid slurry from spray nozzles 22 is injected counter-currently against the flue gas, such that the liquid droplets absorb the gaseous pollutants, mainly, SO₂. The size of the liquid droplets, i.e., in fact, the size of the spray nozzles 22 is chosen such that the liquid droplets are heavy enough not to be carried by the flue gas upwards, but descend down into the reaction tank 4. Alkaline sorbent (AS) is added either to the liquid slurry in the reaction tank 4, or, as shown in FIG. 1, by arrow AS, directly into the circulating liquid slurry pumped to the spray tower 6 and sprayed through nozzles 22 against the flue gas flow. The sorbent is typically lime (CaO or Ca(OH)₂), limestone (CaCO₃) or sodium hydroxide (NaOH, caustic soda). In some cases, also, other sorbents may be used. For instance, seawater, if easily available, may be used. The most common sorbent, however, is lime, as it is already available in power plants, and it is cheap as compared to other applicable sorbents.

The following shows the reactions taking place in the FGD process. If lime is used as the alkaline sorbent, the following reaction applies:

Ca(OH)₂(solid)+SO₂(gas)→CaSO₃(solid)+H₂O (liquid).

And, if limestone is used as the alkaline sorbent, the following reaction applies:

CaCO₃(solid)+SO₂(gas)→CaSO₃(solid)+CO₂(gas).

In both cases, the reaction product is solid calcium sulphite, CaSO₃. In other words, the sprayed lime or limestone slurry droplets sprayed counter-currently to the flue gas flow trap SO₂ molecules, whereafter the droplets end up in the reaction tank 4, in which the calcium sulphite may be allowed to settle for removal. However, CaSO₃ may be treated further in the reaction tank 4 in accordance with the following reaction:

CaSO₃(solid)+nH₂O (liquid)+½O₂ (gas)→CaSO₄(H₂O)ₙ(solid).

Thus, the reaction product is solid calcium sulphite, i.e., gypsum that settles to the bottom of the reaction tank 4 and will be discharged via outlet 10, for instance, for use in the building products industry. The oxidation of CaSO₃ is done by bubbling, in the lower part of the FGD vessel 2, i.e., in the reaction tank 4, oxygen-containing gas, such as air. The gas is introduced into the liquid slurry by means of bubbling via nozzles 14. The agitators 8 provided in the tank 4 circulate the liquid slurry to enhance mass transfer, such that the oxygen in the liquid slurry meets as many CaSO₃ molecules as possible, and that formation of any local inconsistency or concentration peaks is prevented.

The oxygen containing gas that is bubbled into the liquid in the reaction tank 4 in both the above prior art FGD arrangement, as well as in the FGD arrangement discussed earlier in connection with U.S. Pat. No. 4,762,686, joins with the flue gas, enters the spray tower and the stack, thereafter. This is problematic, however, as the bubbled oxygen-containing gas gets vitiated in the reaction tank and dilutes the CO₂ stream in oxy-combustion, and would require special measures for being cleaned before being allowed to discharge to a CO₂ pipeline.

FIG. 2 illustrates a schematic, vertical cross-sectional view of a wet FGD arrangement in accordance with a first preferred embodiment of the present invention. The vertical FGD vessel has reference numeral 40. The other components of the vessel that may be the same as or at least similar to the ones of the prior art (shown in FIG. 1) have the same reference numerals as those in FIG. 1. These are reference numeral 4 to reference numeral 30. The novel structural features have reference numerals 42 to 48.

Thus, to prevent the oxygen-containing gas bubbled via gas inlet header 12 and nozzles 14 into the liquid slurry from joining to the flue gas after having been freed from the liquid slurry, the reaction tank 4 is provided with a horizontal or nearly horizontal separation plate 42. The separation plate 42 is arranged such that it leaves between itself and the liquid surface level L in the reaction tank 4 a space where the bubbled gas may collect, and from where the vitiated or oxygen-depleted gas may be taken out via outlet opening 44 without allowing the gas to enter the spray tower 6 of the FGD vessel 2. The separation plate 42 not only prevents the bubbled gas from entering the spray tower 6, but it also collects the sprayed liquid slurry dropping down from the spray tower 6 (after it has absorbed the SO₂) and guides it to the liquid slurry in the reaction tank 4. This is performed by a downcomer 46, which is, in this embodiment, arranged near a side wall 30 of the reaction tank 4 by means of separating a small portion of the horizontal cross-sectional area of the reaction tank 4 by a substantially vertical extension 48 of the nearly horizontal separation plate 42. The arrangement of the downcomer and gas collector may, however, be altered upon FGD size and other specifications. The extension 48 should extend downward from the lower end of the separation plate 42 at least to the level of the nozzles 14, or preferably, below the level of the nozzles 14, such that the bubbles injected from the nozzles 14 cannot enter the downcomer 46. Here, the separation plate 42 may be a substantially circular (upon its slope, it can be slightly elliptical) plate leaving a small opening for the downcomer 46. It is also possible, however, that the separation plate be formed of two substantially semi-circular plate sections that are joined by a ridge forming a kind of a gas passage having an inverted V-shape leading upwards towards the wall 30 of the reaction tank 4. In such a case, it is preferable to use two downcomers, i.e., one for each plate section. Also, it has to be understood that the ridge runs via the axis of the reaction vessel 4. Yet, the ridge may be arranged to run at a distance from the axis, whereby the plate sections need to be designed accordingly.

In other words, the wet FGD arrangement of the present invention works such that the gas that is bubbled into the liquid slurry via the gas nozzles 14, and that which is raised to and above the liquid level L in the reaction tank 4 is taken separately out of the reaction tank 4 via outlet 44, so that its entry in communication with the flue gas is prevented. In oxy-firing, if pure O₂ is used for the oxidation (a trade-off option), the vitiated O₂ can be ducted to the furnace to form a closed loop for emissions control and without wasting of the excess oxidant. Also, the circulating liquid slurry that is sprayed in the spray tower 6, and that is returning back to the reaction tank 4, is introduced in such a manner to the reaction tank 4 that the bubbled gas is not able to escape from the reaction tank 4 using the same route.

It has to be understood that there is a number of different alternatives for constructing the reaction tank 4 in such a manner that the prerequisites of the invention may be fulfilled.

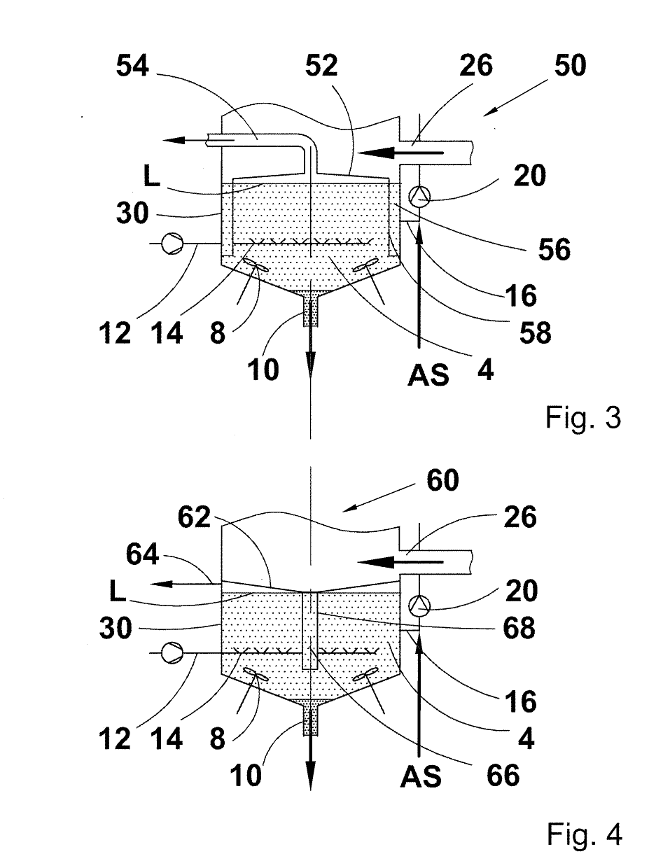

FIG. 3 illustrates a schematic, partial vertical cross-sectional view of a wet FGD arrangement in accordance with a second preferred embodiment of the present invention. This embodiment corresponds to the previous one (shown in FIG. 2), as well as to the prior art FGD arrangement (shown in FIG. 1) in all other aspects, except that the novel structural components have a reference numeral between 52 and 58. Here, the FGD arrangement is given reference numeral 50. The wet FGD arrangement 50 comprises a separation plate 52 that leaves a free space between itself and the liquid level L in the reaction tank 4, such that the vertical dimension of the free space is at its highest in the middle of the FGD vessel 50. In principle, the same construction may also be described in broader terms. In other words, the free space has been arranged such that the vertical dimension of the free space is at its highest, not by the wall 30 of the vessel 50, but at a distance thereof. This kind of separation plate 52 structure requires, for the vitiated or oxygen-depleted air, a gas outlet in the form of a gas outlet conduit 54 that is preferably (though not totally necessary), arranged to have its origin at the tip of the separation plate 52 and to penetrate the wall 30 of the FGD arrangement 50 for taking the vitiated bubbled gas out of the arrangement 50, i.e., out of the reaction tank 4 and thereby, preventing its mixing with the flue gas. Naturally, the gas outlet conduit 54 may also be arranged to run up through the spray tower 6 and to exit through the top of the FGD vessel 50. The FGD arrangement 50 naturally also comprises at least one downcomer 56 (FIG. 3 shows two downcomers, at opposite sides of the reaction tank 4) for the circulating liquid slurry that is dropping from the spray tower 6 and collected on the separation plate 52. In this embodiment, as in the earlier one, too, the lower end of the downcomer 56 extends, preferably, below the level of the gas inlet header 12 and the gas nozzles 14, so that the gas bubbled from the nozzles 22 is not able to enter the downcomer 56. The downcomer(s) 56 may be like the one shown in FIG. 2, i.e., formed between a substantially vertical extension of the separation plate 52 and the wall 30 of the reaction tank 4. Another option, however, is to form the downcomer(s) 56 of pipes 58 arranged at a location where the height of the free space between the liquid level L and the separation plate 52 is at its lowest. The separation plate 52 may be a conical plate structure having its tip pointing upwards. Such a conical plate structure may be coaxial or non-coaxial with the reaction tank 4. Here, the word “conical” also covers various pyramid shapes having a limited number of side faces. Also, the separation plate 52 may form a kind of a roof structure having its ridge either intersecting the axis of the reaction tank 4 or being at a distance thereof. Further, the ridge may be horizontal or even sloped, if desired.

FIG. 4 illustrates a schematic, partial vertical cross-sectional view of a wet FGD arrangement in accordance with a third preferred embodiment of the present invention. This embodiment corresponds to the previous ones, as well as to the prior art FGD arrangement in all other aspects, except for the components having a reference number between reference numeral 62 and reference numeral 68. Here, the FGD arrangement is given reference numeral 60. The wet FGD arrangement 60 comprises a separation plate 62 that leaves a free space between itself and the liquid level L in the reaction tank 4, such that the vertical dimension of the free space is at its highest by the side of the wall 30 of the reaction tank 4. This kind of a separation plate 62 structure utilizes at least one outlet conduit 64 that is similar to that shown in FIG. 2. The FGD arrangement 60 naturally also comprises at least one downcomer 66 for the circulating liquid slurry that is dropping from the spray tower 6 and collected on the separation plate 62. In this embodiment, as in the earlier ones, too, the lower end of the downcomer 66 extends, preferably, below the level of the gas inlet header 12 and the gas nozzles 14, so that the gas bubbled from the nozzles 14 is not able to enter the downcomer 66. The downcomer 66 is preferably formed of a pipe 68 arranged at a location where the height of the free space between the liquid level L and the separation plate 62 is at its lowest. The separation plate 62 of this embodiment is, in a way, an inversion of the separation plate 62 of the previous embodiment illustrated in FIG. 3. In other words, it may be a conical plate structure having its tip pointing downwards. The conical plate structure may be coaxial or non-coaxial with the reaction tank 4. Here, the word “conical” also covers pyramids having a limited number of side faces. Also, the separation plate 62 may form a kind of a V-shaped structure having its bottom either intersecting the axis of the reaction tank 4 or being at a distance thereof. The bottom may also be either horizontal or sloped.

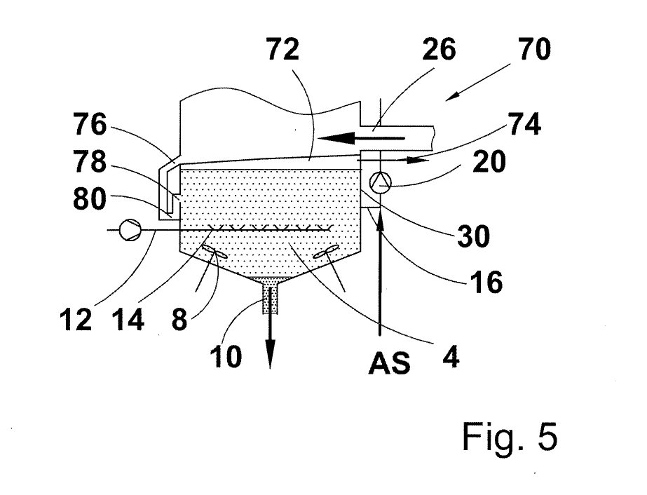

FIG. 5 illustrates a schematic, partial vertical cross-sectional view of a wet FGD arrangement in accordance with a fourth preferred embodiment of the present invention. This embodiment corresponds to the previous ones, as well as to the prior art FGD arrangement in all other aspects except for the components having a reference numeral between reference numeral 72 and reference numeral 80. Here, the FGD arrangement is given reference numeral 70. The wet FGD arrangement 70 comprises a separation plate 72 that leaves a free space between itself and the liquid level L in the reaction tank 4, such that the vertical dimension of the free space is at its highest by the side of the wall 30 of the reaction tank 4. This kind of a separation plate structure 72 utilizes at least one outlet conduit 74 that is similar to that shown in FIG. 2. In this embodiment of the present invention, however, any one of the earlier discussed gas discharge conduits may be utilized. The FGD arrangement 70 comprises at least one downcomer 76 for the circulating liquid slurry that is dropping from the spray tower 6 and collected on the separation plate 72. In this embodiment, contrary to the earlier ones, the downcomer 76 has been constructed such that its lower end need not to be below the level of the nozzles 14. The downcomer 76 is provided with a gas lock 80 that prevents any gas bubbles from travelling along the downcomer 76 to the spray tower 6 by having its inlet opening 78 in the reaction tank 4 in the wall 30 of the reaction tank 4 above the horizontal flow path of the gas lock 80. Here, in FIG. 5, the downcomer 76 has been arranged outside the wall 30 of the reaction tank 4. The downcomer 76, however, may also be arranged inside the reaction tank 4, as long as its lower end is provided with a similar gas lock. The separation plate 72 of this embodiment may, thus, be of any earlier discussed construction.

It has to be understood that it is also possible to build an FGD vessel having a horizontal separation plate. In such a case, the plate is advantageously arranged at a distance from the liquid level in the reaction tank 4. Then, the position of the vitiated gas outlet may be freely chosen along the length of the reaction tank 4 perimeter below the separation plate, or in the separation plate, as discussed in connection with the embodiment of FIG. 3. In a similar manner, the position of the downcomer may also be freely chosen. The only prerequisite is that the downcomer extends at the level of or, preferably, below the level of the gas inlet header 12 and the gas nozzles 14, unless the gas lock of FIG. 5 is used. The horizontal separation plate structure, however, has its downside, i.e., the liquid slurry dropping down from the spray tower 6 does not flow quickly into the downcomer, whereby the particulate CaCO₃ may settle on the plate and form less desired scale on its surface. Thus, preferably, the separation plate slopes towards the downcomer as shown in the embodiments of FIGS. 2-5. Naturally, the sloping of the plate tends to increase the height of the FGD vessel, but a moderate sloping angle of less than five degrees does not necessarily increase the height of the vessel at all, or only slightly. The actual need of providing the separation plate with a slope, however, has to be decided on a case-by-case basis, as it is also possible that the amount of water falling down from the spray tower 6 may be sufficient for flushing the top surface of a horizontal separation plate and preventing any solids accumulation, whereby no sloping is needed. Thereby, a preferable range for the angle of the slope is about zero to about five degrees, but, naturally, the angle of slope may be even more if, for some reason, such is desired. Naturally, the same preferred angular range also applies to sectional, pyramidal or conical separation plates.

It has to be understood, too, that the present invention may not only be used in building new FGD vessels, but also, for modernizing old FGD vessels. In the latter case, a separation plate of a desired construction together with an appropriate downcomer is installed within an existing FGD vessel, and a vitiated or oxygen-depleted gas outlet is arranged through the wall or top of the FGD vessel.

In view of the above description, it has to be understood that only a few most preferred embodiments of the present invention have been discussed. Thus, it is obvious that the invention is not limited only to the embodiments disclosed above, but it can be modified in many ways within the scope of the appended claims. It has to be understood, too, that features of a specific embodiment of the invention may be applied in connection with features of other embodiments within the basic idea of the present invention, or that features from different embodiments may be combined, as long as they result in a working and technically feasible construction.

We claim:

1. A method of desulfurizing flue gas in connection with oxy-combustion, the method comprising steps of:
introducing a sulfur containing gas flow to a flue gas desulfurization arrangement having a spray tower at its top part and a reaction tank at its bottom part, the reaction tank containing liquid slurry having a surface level L;
spraying sorbent-containing liquid slurry to the sulfur containing gas flow;
allowing sulfur-containing molecules to be absorbed into liquid slurry droplets;
allowing the liquid slurry droplets to enter the liquid slurry in the reaction tank;
bubbling oxygen containing gas in the liquid slurry from a gas inlet header and nozzles in the reaction tank, the nozzles being arranged at a certain level in the reaction tank;
allowing sulfur-containing particulates to settle in the reaction tank;
removing the sulfur-containing particulates as a slurry from the reaction tank; and
discharging the bubbled gas that has left the liquid slurry separately from the flue gas from the flue gas desulfurization arrangement.

2. The method of desulfurizing flue gas as recited in claim 1, further comprising a step of guiding the liquid slurry droplets containing sulfur to the liquid slurry in the reaction tank by using a downcomer having a gas lock.

3. The method of desulfurizing flue gas as recited in claim 1, further comprising a step of guiding the liquid slurry droplets containing sulfur to the liquid slurry in the reaction tank by using a downcomer having a gas lock.

4. The method of desulfurizing flue gas as recited in claim 1, wherein pure oxygen is used as the oxygen-containing gas bubbled in the liquid slurry.

5. The method of desulfurizing flue gas as recited in claim 4, further comprising a step of circulating the bubbled gas that has left the liquid slurry to a boiler.

6. An arrangement for desulfurizing flue gas in connection with oxy-combustion, the arrangement including:
(a) a wall, the wall housing having:
(i) a spray tower at its top part, the spray tower being provided with a sprayer for spraying liquid slurry to the flue gas, and
(ii) a reaction tank at its bottom part;
(b) a duct below the sprayer for introducing flue gas into the arrangement;
(c) a flue gas discharge above the sprayer for discharging flue gas from the arrangement;
(d) a bubbler for bubbling oxygen-containing gas in the reaction tank;
(e) a circulator for circulating liquid slurry from the reaction tank to the sprayer in the spray tower;
(f) a solids slurry discharge for removing solids slurry from the reaction tank; and
(g) a separator for keeping the bubbled gas and the flue gas apart by removing bubbled gas from the desulfurization arrangement separately from the flue gas discharge.

7. The flue gas desulfurization arrangement as recited in claim 6, wherein the separator for keeping the bubbled gas and flue gas apart comprises a separation plate between the reaction tank and the spray tower below the duct for flue gas introduction, and a gas outlet for removing bubbled gas from the arrangement separately from the flue gas discharge.

8. The flue gas desulfurization arrangement as recited in claim 7, further comprising at least one downcomer extending below the separation plate and being arranged in flow communication with the spray tower for introducing the sprayed liquid slurry back to the reaction tank.

9. The flue gas desulfurization arrangement as recited in claim 8, wherein the at least one downcomer is provided at its lower end with a gas lock.

10. The flue gas desulfurization arrangement as recited in claim 8, wherein the bubbler comprises nozzles, the nozzles being arranged at a level in the reaction tank, and the downcomer extending below the level of the nozzles.

11. The flue gas desulfurization arrangement as recited in claim 7, wherein the gas outlet is arranged in the wall below the separation plate.

12. The flue gas desulfurization arrangement as recited in claim 7, wherein the gas outlet is arranged in communication with the separation plate.

13. The flue gas desulfurization arrangement as recited in claim 12, wherein the gas outlet is arranged in one of (i) the wall above the separation plate and (ii) the top of the flue gas desulfurization arrangement.

14. The flue gas desulfurization arrangement as recited in claim 7, wherein the separation plate is formed of at least one plate section.

15. The flue gas desulfurization arrangement as recited in claim 7, wherein the separation plate is one of a conical and a pyramidal shape.

16. The flue gas desulfurization arrangement as recited in claim 7, wherein the separation plate, or a section thereof, is arranged to have a slope of about zero to about five degrees.

17. A method of modernizing a desulfurization arrangement for use in connection with oxy-combustion, the desulfurization arrangement including a wall housing a spray tower at its top part, the spray tower including a sprayer for spraying liquid slurry to the flue gas, and a reaction tank at its bottom part, a flue gas discharge above the sprayer for discharging flue gas from the arrangement, and a duct below the sprayer for introducing flue gas into the desulfurization arrangement, the method comprising the step of:
providing the desulfurization arrangement with a separator for keeping the bubbled gas and flue gas apart by removing bubbled gas from the desulfurization arrangement separately from the flue gas discharging means.

18. The method of modernizing desulfurization arrangement as recited in claim 17, wherein the separator for keeping the bubbled gas and flue gas apart comprises a separation plate between the reaction tank and the spray tower below the duct for introducing the flue gas, and a gas outlet for removing bubbled gas from the reaction tank separately from the flue gas discharge.

19. The method of modernizing a desulfurization arrangement as recited in claim 18, wherein the gas outlet is provided in the wall below the separation plate.

20. The method of modernizing a desulfurization arrangement as recited in claim 18, wherein the gas outlet is a gas outlet conduit leading through one of (i) the separation plate and the wall and (ii) the top of the desulfurization vessel.

21. The method of modernizing a desulfurization arrangement as recited in claim 18, further comprising a step of providing a downcomer in communication with the separation plate for introducing the sprayed liquid slurry from the spray tower back to the reaction tank.

22. The method of modernizing a desulfurization arrangement as recited in claim 21, further comprising a step of providing the downcomer with a gas lock.
